(19) United States
(12) Patent Application Publication
(10) Pub. No.: US 2006/0046594 A1
(43) Pub. Date: Mar. 2, 2006

(54) Flame retardant sound dampening appliance insulation

(76) Inventor: David Starrett, Greer, SC (US)

Correspondence Address: JAMES M. ROBERTSON, 233 SOUTH PINE STREET, SPARTANBURG, SC, 29302, US

(21) Appl. No.: 11/214,007

(22) Filed: Aug. 29, 2005

Related U.S. Application Data
(60) Provisional application No. 60/605,434, filed on Aug. 30, 2004.

(51) Int. Cl. B32B 5/02; B32B 27/12; D04H 13/00

(52) U.S. Cl. 442/136; 442/59; 442/361; 442/327

(57) ABSTRACT

An appliance insulating panel of fibrous construction. The insulating panel incorporates substantial percentages of cotton fiber while retaining substantial flammability resistance. The insulating panel construction provides exceptional heat blocking and sound damping characteristics.

### CROSS-REFERENCE TO RELATED APPLICATIONS

This application claims the benefit of and priority from U.S. Provisional Application 60/605,434 having a filing date of Aug. 30, 2004 the contents of which are hereby incorporated by reference in their entirety.

### TECHNICAL FIELD

The present invention relates generally to fibrous insulation for paneled or wrapped disposition in at least partial surrounding relation to an interior chamber of a heat-generating appliance. More particularly, the invention relates to an insulating material formed from a blend of cotton and polymeric fibers held together in a cohesive structure by fusion bonding between the fiber constituents and wherein the cotton fibers are pretreated with a flame retardant composition prior to blending with the polymeric fibers such that flame retardant treated cotton fibers are disposed substantially throughout the insulating material.

### BACKGROUND OF THE INVENTION

In a number of appliance environments a heated interior chamber is used to hold articles being treated by heat. By way of example only, such appliance environments include clothes dryers, dish washers and the like. In such environments it is desirable to provide a degree of insulation between the interior chamber and the exterior surrounding cabinet so as to reduce energy consumption and to reduce the possibility of the exterior cabinet becoming overheated. It is also desirable to provide a degree of sound insulation to reduce operational noise. Insulating materials such as fiberglass and the like may function well to contain heat but may have limited sound dampening capacity unless a substantial thickness is used. Moreover such materials are often irritating to the skin and thus may undesirable during the manufacturing process. Cotton-based materials are generally non-irritating to users but they may have limited resistance to flammability. Flame resistance may be important if the interior or associated component such as an electric motor, bearing or the like becomes overheated.

### SUMMARY OF THE INVENTION

This invention provides advantages and alternatives over the prior art by providing insulating materials suitable for heat-generating appliances. The insulating materials contain substantial percentages of cotton fiber while retaining substantial flammability resistance. The insulating materials provide exceptional heat blocking and sound damping characteristics.

According to a potentially preferred feature, the cotton fibers may be treated with a flame retardant composition and dried prior to blending with other fiber constituents.

According to another potentially preferred feature, the cotton fibers may be blended with a polymeric fiber including a relative low melting point constituent and subjected to a heat treatment to fusion bond the fibers together at bonding points across the thickness.

### BRIEF DESCRIPTION OF THE DRAWINGS

The present invention will now be described by way of example only with reference to the accompanying drawings which constitute a portion of the specification herein and in which:

FIG. 1 is a schematic illustration of a processing line for forming a fibrous insulating material for a heat-generating appliance;

FIG. 2 is a cross-section of a representative fibrous insulating material formed by the processing line in FIG. 1;

FIG. 3 is a partial cut-away view of a clothes dryer incorporating an insulating panel of fibrous insulating material formed by the processing line in FIG. 1; and

FIG. 4 is a schematic illustration of an alternative processing line for forming a fibrous insulating material for a heat-generating appliance.

While the present invention has been illustrated and generally described above and will hereinafter be described in connection with certain potentially preferred embodiments, procedures, and practices, it is to be understood that in no case is the invention to be limited to such illustrated and described embodiments, procedures, and practices. On the contrary, it is intended that the present invention shall extend to all alternatives, modifications, and equivalents as may embrace the principals of the present invention within the true scope and spirit thereof.

### DESCRIPTION OF PREFERRED EMBODIMENTS

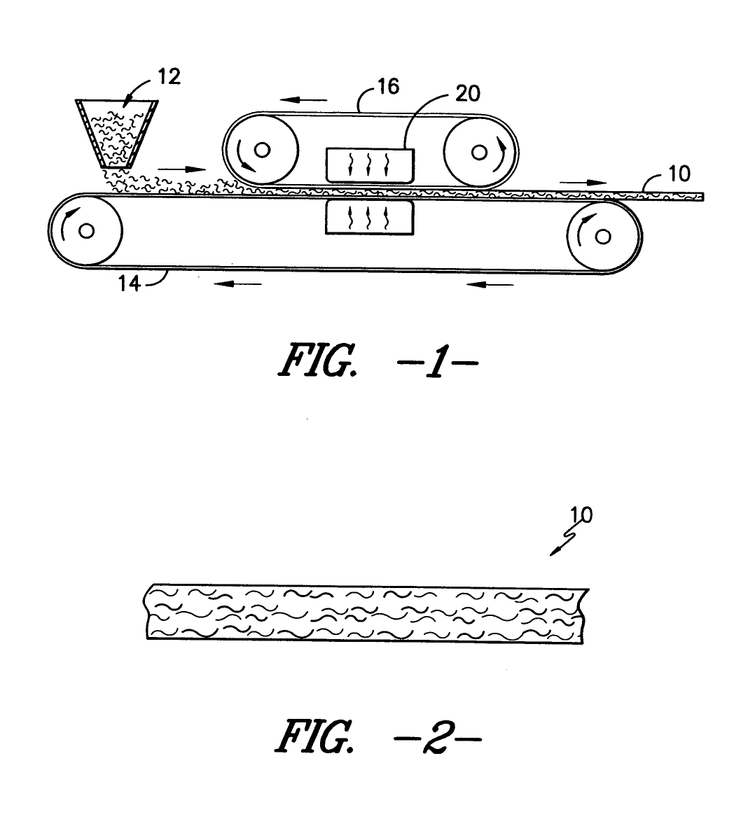

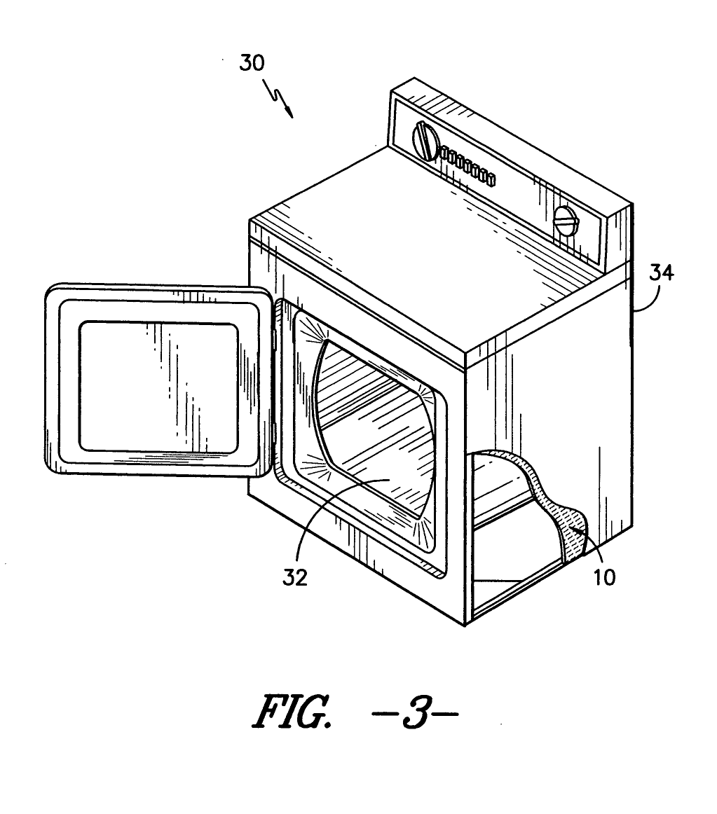

Reference will now be made to the drawings, wherein to the extent possible, like reference numerals are utilized to designate like components throughout the various views. In FIG. 1 there is illustrated a processing line for formation of a fibrous insulation material 10 as will be described more fully hereinafter. Of course, it is to be understood that the illustration is highly schematic and that the process may be the subject of any number of alternative arrangements as will be recognized as being suitable to those of skill in the art upon reference to this specification.

As illustrated, in the formation process, a collection of blended fibers 12 is deposited upon a carrier belt 14 for transport to a leveling belt 16 disposed in opposing relation to the carrier belt 14 such that a space of controlled thickness is established between the carrier belt 14 and the leveling belt 16. The fibers 12 are preferably a blend of cotton fibers intermixed with polymeric fibers. A blend of cotton fibers and polyester fibers may be particularly preferred although other polymeric fibers such as polypropylene, nylon and the like are also contemplated. By way of example only, a blend of about 20% to 80% cotton, more preferably about 40% to 60% cotton and most preferably about 50% cotton with the remainder being polyester may be particularly desirable.

The blend of fibers 12 preferably includes some percentage of a relatively low melting point constituent so as to permit the heat activated point bonding of fibers to one another upon application of heat. According to one contemplated practice, the blend of fibers 12 is made up of cotton within the ranges specified above in combination with polyester fibers with different melting point constituents. According to such practice, it is contemplated that about 5% to about 75% of the polyester fibers may be so called “bi-component” polyester fibers incorporating a sheath of low melting point CO-PET polyester around a standard PET polyester core. As will be appreciated, upon the application of heat, the sheath material undergoes preferential flow and bonding to surrounding fiber constituents. Of course, other forms of low melting point material such as discrete fibers of low melting point material may also be utilized.

As illustrated, after being deposited on the carrier belt 14, the blend of fibers 12 is conveyed to a leveling belt 16 disposed in spaced opposing relation to the carrier belt 14. The fibers are thus forced into a space of defined thickness between the carrier belt 14 and the leveling belt 16. According to the illustrated practice, while the fibers 12 are constrained between the carrier belt 14 and the leveling belt 16 they are subjected to a heating operation at an oven 20 so as to facilitate the heat fusion of fibers to one another by the melting and resolidification of the low melting point constituent. The resultant fibrous insulation material 10 is thus formed from a blend of cotton fibers that are point bonded to polyester or other polymeric fibers by heat activated thermoplastic material. The bonding also fixes the height to a level substantially corresponding to the height between the carrier belt 14 and the leveling belt 16. The fibrous insulation material 10 is preferably characterized by a mass per unit area of about 1.3 ounces per square foot to about 20 ounces per square foot. One potentially preferred construction is characterized by a mass per unit area of about 4 ounces per square foot with a thickness of about 1 inch.

As previously noted, the fibrous insulation material 10 is preferably characterized by substantial flammability resistance. According to one contemplated practice, such flammability resistance is imparted by treatment of the cotton constituent fibers with a flame resistant chemical composition prior to blending with the polymeric constituent fibers. By way of example only, and not limitation, the cotton constituent fibers may be treated with flame resistant chemicals such as di-ammonium phosphate or the like and then be allowed to dry prior to being blended with the polyester or other polymeric fiber constituent. Thus, the treated cotton fibers will be distributed throughout the blend and the finished fibrous insulation material 10. This provides enhanced uniformity in fire resistance thoughout the formed structure.

As further noted above, the fibrous insulation material 10 also provides a substantial level of sound dampening. In order to promote such sound dampening it is contemplated that the cotton and polymeric fibers preferably have relatively low linear density ratings in the range of about 4 denier or less, more preferably about 3 denier or less and most preferably about 1 to 3 denier. Of course, higher or lower denier ratings may also be utilized if desired.

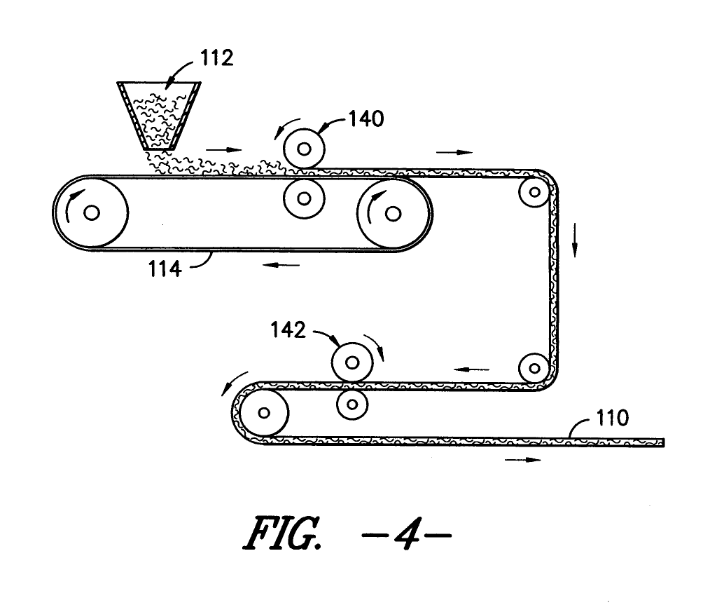

Depending upon the level of low melting point material included within the blend of fibers, the fibrous insulation material 10 may be characterized by differing levels of flexibility ranging from stiff to substantially pliable. By varying the stiffness level the fibrous insulation material 10 may be adapted for insulation of numerous different appliances. By way of example, a relatively pliable costruction may be desirable to wrap around the interior of a dishwasher while a more rigid panel structure may be desirable for use as insulation panels at the interior of a clothes dryer cabinet. By way of example only, and not limitation, in FIG. 3 there is illustrated a clothes dryer 30 having a heated interior chamber 32 surrounded by a cabinet 34. As illustrated, panels of the fibrous insulation material 10 may be disposed within the cabinet 34 so as to provide a flame barrier at least partially surrounding the interior chamber 32.

It is also contemplated that insulation materials of increased density and rigidity may be produced by alternative processing techniques. By way of example only, and not limitation, FIG. 4 illustrates a process for forming a stiffened panel 110 wherein the leveling belt and oven are replaced by a pair of cooperating heated calendering roll stations 140, 142. As will be appreciated, at such stations a pressure applying heated roll presses down on the fibers 112 blended as previously described and deposited on the belt 114. This heat and pressure activates low melting point constituents within the fiber blend thereby causing the desired point bonding fusion between the fibers. In addition, the heated rolls provide an ironing effect to the surface of the panel 110, thereby smoothing the surface which may be desirable in some environments of use. While double sided calendering is illustrated, it is likewise contemplated that calendering may be performed across only a single side if desired.

It is to be understood that while the present invention has been illustrated and described in relation to several potentially preferred embodiments, constructions, and procedures that such embodiments, constructions, and procedures are illustrative and exemplary only and that the present invention is in no event to be limited thereto. Rather it is contemplated that modifications and variations embodying the principles of the present invention will no doubt occur to those of ordinary skill in the art. It is therefore contemplated and intended that the present invention shall extend to all such modifications and variations as may incorporate the broad aspects of the present invention within the true scope and spirit thereof.

What is claimed is:

1. In a clothes dryer, a sound damping flame retardant insulation panel, said insulation panel comprising a blend of fibers formed into a panel of predefined thickness, the blend of fibers comprising about 20% to about 80% cotton fibers intermixed with a plurality of polymeric fibers, the blend of fibers further including a heat activatable bonding constituent, wherein at least a portion of the cotton fibers have a surface coating treatment of di-ammonium phosphate, at least a portion of the cotton fibers being melt fused in point bonding relation to at least a portion of the polymeric fibers by the heat activatable bonding constituent to provide internal cohesion within the panel, and wherein the cotton fibers with the surface coating treatment of di-ammonium phosphate are distributed substantially throughout the panel.

2. The invention of claim 1, wherein at least a portion of the polymeric fibers comprise bi-component polyester fibers and wherein the heat activatable bonding constituent comprises an outer sheath portion of said bicomponent polyester fibers.

3. The invention of claim 1, wherein the insulation panel is characterized by a mass per unit area of about 1.3 to about 20 ounces per square foot.

4. The invention of claim 1, wherein the insulation panel is characterized by a mass per unit area of about 4 ounces per square foot with a thickness of about 1 inch.

5. The invention of claim 1, wherein the blend of fibers comprises about 20% to about 70% cotton fibers.

6. The invention of claim 1, wherein the blend of fibers comprises about 20% to about 60% cotton fibers.

7. The invention of claim 1, wherein the blend of fibers comprises about 20% to about 50% cotton fibers.

8. The invention of claim 1, wherein the blend of fibers comprises about 30% to about 70% cotton fibers.

9. The invention of claim 1, wherein the blend of fibers comprises about 40% to about 70% cotton fibers.

10. The invention of claim 1, wherein the blend of fibers comprises about 50% to about 70% cotton fibers.

11. The invention of claim 1, wherein the blend of fibers comprises about 50% cotton fibers and about 50% bicomponent polyester fibers.

12. In a clothes dryer, a sound damping flame retardant insulation panel, said insulation panel comprising a blend of fibers formed into a panel of predefined thickness, the blend of fibers comprising about 40% to about 60% cotton fibers intermixed with a plurality of polymeric fibers, the blend of fibers further including a heat activatable bonding constituent, wherein at least a portion of the cotton fibers have a surface coating treatment of di-ammonium phosphate, at least a portion of the cotton fibers being melt fused in point bonding relation to at least a portion of the polymeric fibers by the heat activatable bonding constituent to provide internal cohesion within the panel, and wherein the cotton fibers with the surface coating treatment of di-ammonium phosphate are distributed substantially throughout the panel, wherein at least a portion of the polymeric fibers comprise bi-component polyester fibers and wherein the heat activatable bonding constituent comprises an outer sheath portion of said bicomponent polyester fibers.

13. The invention of claim 12, wherein the insulation panel is characterized by a mass per unit area of about 1.3 to about 20 ounces per square foot.

14. The invention of claim 1, wherein the insulation panel is characterized by a mass per unit area of about 4 ounces per square foot with a thickness of about 1 inch.

15. The invention of claim 12, wherein the blend of fibers comprises about 50% cotton fibers and about 50% bicomponent polyester fibers.

16. In a clothes dryer, a sound damping flame retardant insulation panel of defined thickness, said insulation panel consisting essentially of about 40% to 60% cotton fibers intermixed with about 40% to 60% bi-component polyester fibers, wherein the bicomponent polyester fibers comprise a core of a first polyester polymer characterized by a first melting point and a sheath of a second polyester polymer characterized by a second lower melting point and wherein at least a portion of the cotton fibers have a surface coating treatment of di-ammonium phosphate, at least a portion of the cotton fibers being point bonded to at least a portion of the polyester fibers by melt fusion of the second polyester polymer, and wherein the cotton fibers with the surface coating treatment of di-ammonium phosphate are distributed substantially throughout the panel.

17. The invention of claim 16, wherein the insulation panel is characterized by a mass per unit area of about 4 ounces per square foot with a thickness of about 1 inch.

18. The invention of claim 16, wherein said insulation panel consists essentially of about 50% cotton fibers intermixed with about 50% bi-component polyester fibers and wherein at least a portion of the cotton fibers have a surface coating treatment of di-ammonium phosphate.
